(19) United States
(12) Patent Application Publication
(10) Pub. No.: US 2008/0293286 A1
(43) Pub. Date: Nov. 27, 2008

(54) Cable connector and circuit board connector to be connected to the same

(75) Inventor: Ikuo Denpouya, Tokyo (JP)

Correspondence Address: KUBOTERA & ASSOCIATES, LLC, SUITE 202, 200 DAINGERFIELD ROAD, ALEXANDRIA, VA, 22314, US

(73) Assignee: Hirose Electric Co., Ltd.

(21) Appl. No.: 12/153,656

(22) Filed: May 22, 2008

(30) Foreign Application Priority Data
May 25, 2007 (JP) 2007-139210

(51) Int. Cl. H01R 13/627; H01R 12/00

(52) U.S. Cl. 439/358; 439/79

(57) ABSTRACT

A connector for a cable includes a plurality of a connector portions and a connecting portion. Each of the connector portions has a terminal to which a cable is wired. The connecting portion integrally connects the connector portions at positions so that the cables of the connector portions are parallel to each other in a same direction. A fitting surface is formed on an outer wall surface of each of the connector portions that extends in the fitting direction. When the connectors are fitted with each other, the fitting surface extends to a protruding portion. The protruding portion protrudes along the outer wall surface of the connector portion in the fitting direction beyond a position of a front side of the connector portion. The front side of the connector portion faces a bottom surface of a receiving recess portion of the connector for a circuit board.

### BACKGROUND OF THE INVENTION AND RELATED ART STATEMENT

The present invention relates to an electrical connector for a cable or a cable connector and an electrical connector for a circuit board or a circuit board connector to be connected to the cable connector.

An electrical connector for a circuit board (hereinafter called a circuit board connector) that is attached to a circuit board and an electrical connector for a cable (hereinafter called a cable connector) that is fitted into the connector for a circuit board in a direction perpendicular to a surface of the circuit board and has a cable extending in parallel to the circuit board are disclosed in, for example, Patent Reference.

Patent Reference: Japanese Patent Publication No. 2002-33150

In the Patent Reference, a housing of the connector for a circuit board has an approximate rectangular solid outer shape. Further, a recess portion opens upwardly in order to receive the connector for a cable with a cable as a mating connector. The recess portion opens on one sidewall toward a side portion over a range of a depth of the recess portion. The cable of the connector for a cable is wired to be parallel to a surface of the circuit board and extends toward a side. When the connector for a cable is fitted into the connector for a circuit board from above, the cable extends through the opening portion on a side of the recess portion.

The connector for a circuit board opens widely in one sidewall thereof toward a side portion. Accordingly, the connector for a cable is guided along fitting surfaces formed of remaining three sidewalls of the recess portion of the connector for a circuit board. The three fitting surfaces are situated in the same height range (range in the fitting direction). Further, in the connector for a cable, fitting begins and is completed in the three fitting surfaces at the same time.

Further, on the fitting surface, a fitting length is a length to a front side of the connector for a cable in a fitting direction, or a length to a bottom surface of the recess portion to which the front side of the connector for a cable is adjacent on the connector for a circuit board side. The connector disclosed in Patent Reference has a terminal in a position in which three cables are adjacent to each other inside of the recess portion.

In general, it is preferred that a fitting surface of a connector be long in a fitting direction. Specifically, when a cable of the connector for a cable extends toward a side, as described above, a peripheral wall of a housing is formed, so that a portion thereof opens for the cable to extend outwardly; thereby reducing an area of the fitting surface. Accordingly, a fitting length tends to be enlarged so that sufficiently fitting surface can be obtained.

In the situation, in Patent Reference, each of the three fitting surfaces is situated in the same range in the fitting direction. Accordingly, the three fitting surfaces begin and complete fitting at the same time. In other words, the fitting length is downsized when a size of a fitting direction of the connector is downsized, while a size of the fitting direction of the connector is enlarged when a sufficient fitting length is ensured.

When the connector is used for power supply, a space distance and a creepage distance must be sufficiently ensured in order to electrically insulate between the terminals of the adjacent cables without isolating with an insulation member.

The space distance is a shortest distance that passes a space between the terminals. The creepage distance is a shortest distance along a surface of the insulation member between the terminals. In the connector disclosed in Patent Reference, the terminals are arranged to be adjacent to each other. Accordingly, the space distance and the creepage distance are small.

In view of the problems described above, an object of the present invention is to provide a connector for a cable and a connector for a circuit board that has a sufficient fitting length while having a small size in a fitting direction and can ensure a sufficient space distance and a creepage distance even if the connector is used as a power supply cable.

Further objects of the invention will be apparent from the following description of the invention.

### SUMMARY OF THE INVENTION

In order to attain the objects described above, according to the present invention, a connector for a cable or a cable connector and a connector for a circuit board or a circuit board connector that receives the cable connector are configured as follows.

According to the present invention, the connector for a cable is fitted into the connector for a circuit board or a mating connector in a fitting direction that is perpendicular to the circuit board. The connector for a circuit board is attached to the circuit board.

The connector for a cable includes a plurality of a connector portions and a connecting portion. Each of the connector portions has a terminal to which a cable is wired. The cable extends outwardly from a housing in a direction parallel to a surface of the circuit board. The connecting portion integrally connects the connector portions at positions so that the cables of the connector portions are parallel to each other in a same direction.

A fitting surface is formed on an outer wall surface of each of the connector portions that extends in the fitting direction. When the connectors are fitted with each other, the fitting surface extends to a protruding portion. The protruding portion protrudes along the outer wall surface of the connector portion in the fitting direction beyond a position of a front side of the connector portion. The front side of the connector portion faces a bottom surface of a receiving recess portion of the connector for a circuit board.

In the connector for a cable of the present invention, a plurality of the connector portions is connected with the connecting portion. The connector portions are away from each other for a size of the connecting portion. The fitting surface is formed in each of the connector portions and extends to the protruding portion that protrudes from the front side of the connector portion.

Accordingly, a large area of the fitting surface and a long fitting length are secured. Further, the fitting surfaces are situated to be away from each other, thereby preventing and minimizing oblique fitting. As a result, fitting is stable and secured.

Further, the connecting portion is provided between the connector portions. Accordingly, a space distance and a creepage distance between the terminals of the connector portions are enlarged, thereby improving insulation strength between the terminals.

According to the present invention, it is preferred that the fitting surfaces be formed on the two outer wall surfaces of the connector portions. The outer wall surfaces are perpendicular to each other. Accordingly, the connectors are positioned in the two directions perpendicular to the fitting direction. Further, the connectors are positioned, so that an inclination around an axis line is regulated. The axis line is the fitting direction.

According to the present invention, it is preferred that the protruding portion be provided between the terminals of the two connector portions that are adjacent to each other. Accordingly, a space distance and a creepage distance between the terminals of the connector portions are also enlarged.

According to the present invention, it is preferred that a front portion of the connecting portion be recessed from the front side of the connector portion in the fitting direction. Accordingly, a creepage distance is enlarged.

According to the present invention, the connector for a circuit board is attached to the circuit board and receives the connector for a cable in the fitting direction that is perpendicular to the circuit board.

According to the present invention, the connector for a circuit board includes a plurality of connector portions and a connecting portion. The connector portion receives the connector for a cable in a receiving recess portion thereof at a plurality of positions. In the connector for a cable, the cable extends from a housing in a direction parallel to a surface of the circuit board. The receiving recess portions are away from each other. The connecting portion integrally connects the connector portions.

A fitting surface of each of the connector portions is formed in on an inner wall surface of the receiving recess portion. Each of the connector portions extends in the fitting direction. When the connectors are fitted with each other, the fitting surface extends to a recess portion. The recess portion is recessed along an inner wall surface of the connector portion in the fitting direction beyond a position of a bottom face of the receiving recess portion.

In the present invention, the connector for a circuit board is fitted with the connector for a cable. A plurality of the connector portions is connected with the connecting portion. The connector portions are away from each other for a size of the connecting portion. The fitting surface is formed in each of the connector portions. Further, the fitting surface extends to the recess portion that is recessed from a position of the bottom surface of the receiving recess portion of the connector portion.

Accordingly, a large area of the fitting surface and a long fitting length are secured. Further, the fitting surfaces are situated to be away from each other, thereby preventing or minimizing oblique fitting. As a result, fitting is stable and secured. Further, the connecting portion is provided between the connector portions.

Accordingly, a space distance and a creepage distance between the terminals of the connector portions are enlarged, thereby improving insulation strength between the terminals.

According to the present invention, it is preferred that the fitting surfaces be formed on the two inner wall surfaces of the connector portions. The two inner wall surfaces are perpendicular to each other. Accordingly, the connectors are positioned in the two directions that are perpendicular to the fitting direction. Further, the connectors are positioned, so that an inclination around an axis line is regulated. The axis line is the fitting direction.

According to the present invention, it is preferred that the recess portion be formed between the terminals of the two connector portions that are adjacent to each other. Accordingly, a space distance and a creepage distance between the terminals of the connector portions are also enlarged.

According to the present invention, it is preferred that an upper face of the connecting portion be formed to protrude upwardly from the bottom surface of the receiving recess portion of the connector portion, thereby enlarging a creepage distance.

In the connector for a cable of the present invention, as described above, a plurality of the connector portions to which the cables are wired is integrally formed at intervals in the connecting portion. Further, the fitting surface is formed on the outer wall surface of each of the connector portions. The outer wall surfaces of the connector portions are situated at an interval with each other. The fitting surface extends to the protruding portion. The protruding portion protrudes from the front side of the connector for a cable that faces the bottom surface of the receiving recess portion of the connector for a circuit board or the mating connector.

Accordingly, a long length and area of the fitting surface can be secured. Further, the fitting surfaces of the connector portions are situated at sufficient intervals with each other due to the connecting portion, which effectively prevents oblique fitting of the connector. Further, the connector for a circuit board that receives the connector for a cable is fitted into the connector for a cable. Accordingly, even if an opening portion is provided for the cable to extend on one of the outer walls, a sufficient fitting length and a fitting area are secured, thereby preventing oblique fitting.

Further, a large space distance and a creepage distance between the terminals of the both connector portions can be obtained because there is the connecting portion between the connector portions, thereby improving insulation strength between the terminals.

### BRIEF DESCRIPTION OF THE DRAWINGS

FIG. 1 is a perspective view showing a cable connector and a circuit board connector according to an embodiment of the present invention;

FIGS. 2(A) and 2(B) are perspective views showing a holding member of the cable connector, wherein FIG. 2(A) is an overall view of the holding member, and FIG. 2(B) is a sectioned view of the holding member cut in half along a centerline thereof;

FIGS. 3(A) and 3(B) are sectional views showing the cable connector and the circuit board connector taken along a line 3-3 in FIG. 1, wherein FIG. 3(A) shows a state before the cable connector and the circuit board connector are fitted, and FIG. 3(B) shows a state after the cable connector and the circuit board connector are fitted;

FIGS. 4(A) and 4(B) are sectional views showing the cable connector and the circuit board connector taken along a line 4-4 in FIG. 1, wherein FIG. 4(A) shows a state before the cable connector and the circuit board connector are fitted, and FIG. 4(B) shows a state after the cable connector and the circuit board connector are fitted; and

FIGS. 5(A) and 5(B) are sectional views showing the cable connector and the circuit board connector taken along a line 5-5 in FIG. 1, wherein FIG. 5(A) shows a state before the cable connector and the circuit board connector are fitted, and FIG. 5(B) shows a state after the cable connector and the circuit board connector are fitted.

### DETAILED DESCRIPTION OF PREFERRED EMBODIMENTS

Hereunder, embodiments of the present invention will be explained with reference to the accompanying drawings.

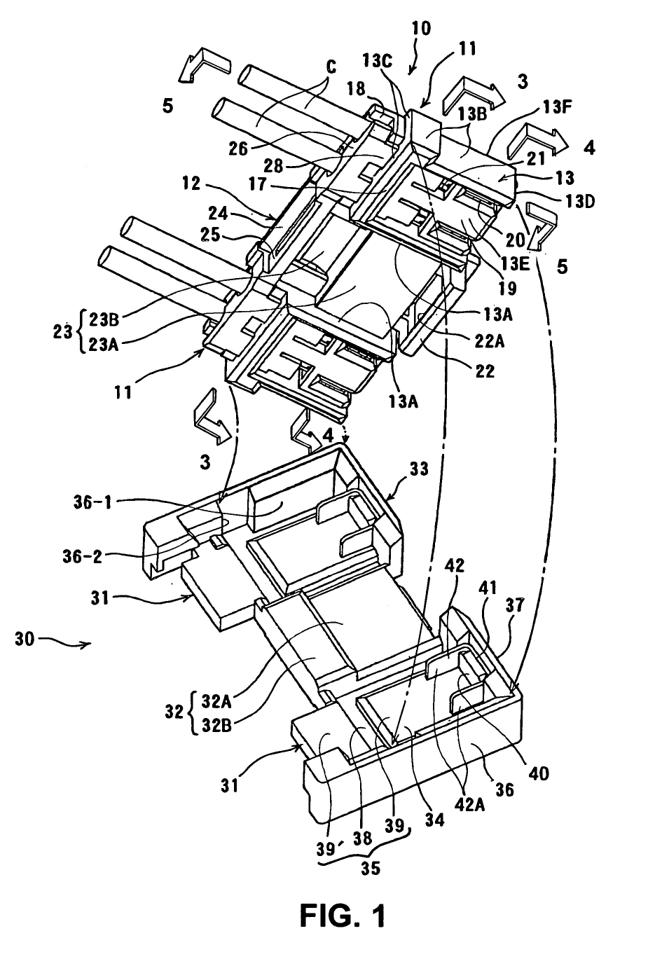

FIG. 1 is a perspective view showing a connector for a cable or a cable connector 10 and a connector for a circuit board or a circuit board connector 30 according to an embodiment of the present invention. The connector for a cable 10 is fitted into the connector for a circuit board 30. A top view of the connector for a circuit board 30 is shown without a circuit board that is attached to the lower surface thereof in FIG. 1. Further, a bottom view of the connector for a cable that is fitted into the connector for a circuit board 30 is shown in FIG. 1.

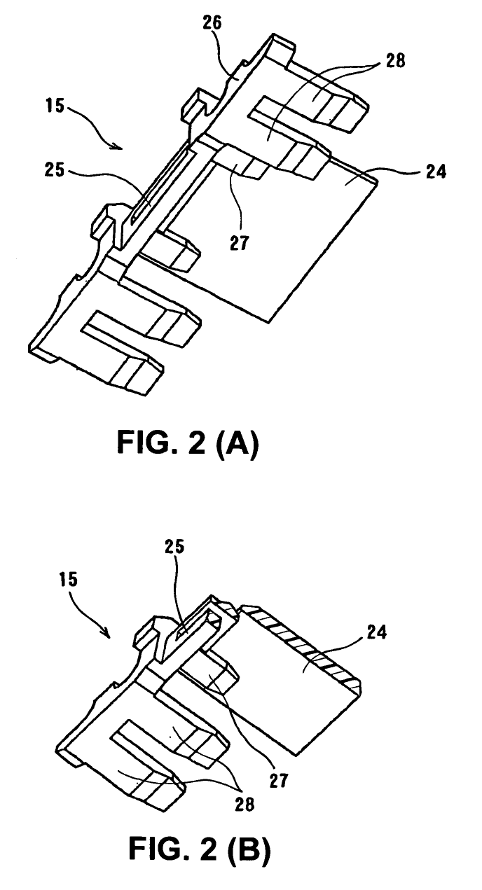

FIG. 1 shows a state of the connector for a cable 10 and the connector for a circuit board 30 before fitting. FIGS. 2(A) and 2(B) are perspective views showing a holding member of the cable connector 10. The holding member holds a terminal having a cable inside a housing in the connector for a cable 10 shown in FIG. 1. More specifically, FIG. 2(A) is an overall view, and FIG. 2(B) is a sectional perspective view of the holding member cut in half along a centerline thereof.

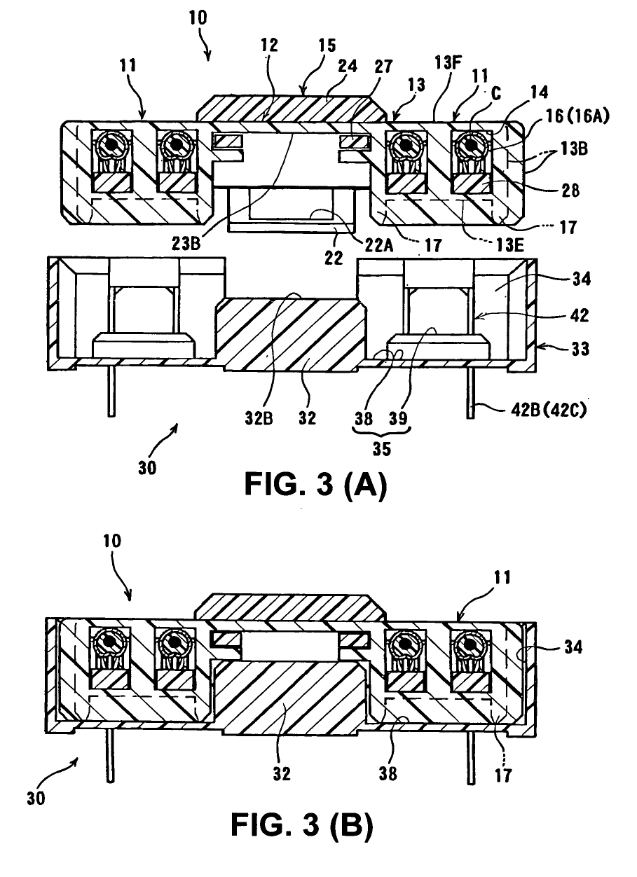

FIGS. 3(A), 3(B), 4(A), 4(B), 5(A), and 5(B) are sectional views showing the cable connector 10 and the circuit board connector 30 taken along lines 3-3, 4-4, and 5-5 in FIG. 1, respectively. FIGS. 3(A), 4(A), and 5(A) show the cable connector 10 and the circuit board connector 30 before the both connectors are fitted. FIGS. 3(B), 4(B), and 5(B) the cable connector 10 and the circuit board connector 30 after the both connectors are fitted.

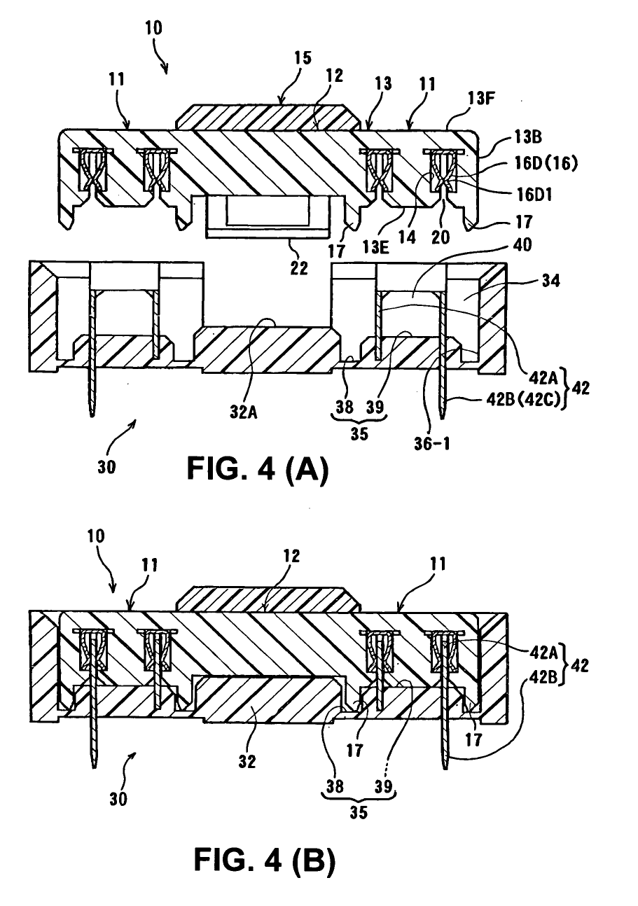

As shown in FIG. 1, FIG. 3(A), and FIG. 4(A), the connector for a cable 10 is provided with two connector portions 11 that are away from each other with an interval therebetween. The connector portions 11 are connected by a connecting portion 12. The connecting portion 12 is situated between the connector portions 11. Accordingly, housings 13 of the connector portions 11 and the connecting portion 12 are integrally formed as a housing of the connector for a cable 10.

In the embodiment, two cables C extend from each of the connector portions 11 in the same direction. The cables C are parallel to each other. It is supposed that there is a center surface perpendicular to a surface including the axis lines (the axis lines that extend in a longitudinal direction of the cable) of all the cables C and passing through a center position (the center position in a direction in which the connector portions 12 are connected) of the connecting portion 12. The connecting portion 12 is formed to be symmetrical with respect to the center surface. Further, the connector portions 11 are situated at symmetrical positions to each other with respect to the center surface and are symmetrical to each other.

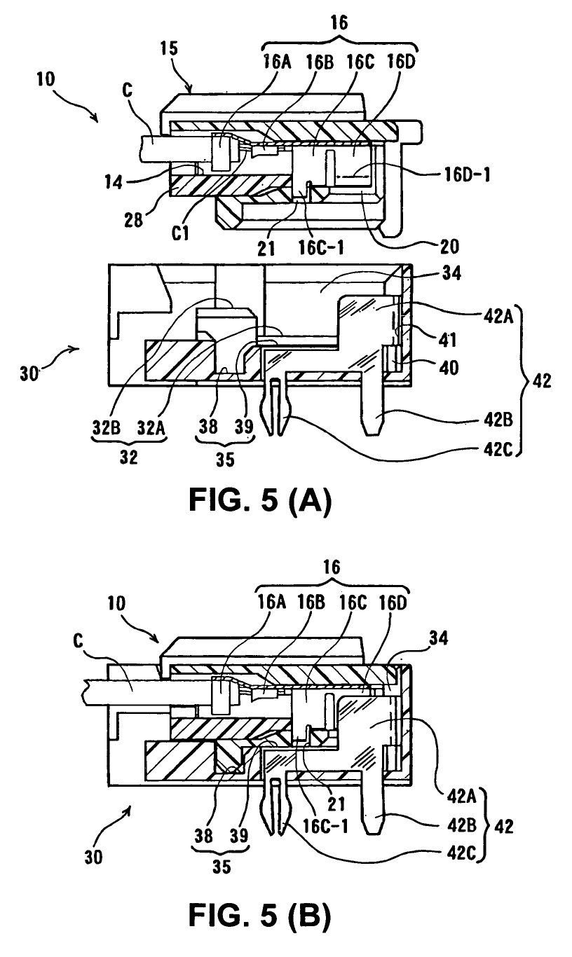

The connector portions 11 are formed to be symmetrical on both sides of the connecting portion 12 and are integrally connected to the connecting portion 12. The connector portion 11 includes the housing 13, a terminal 16 (shown in FIG. 5(A)), and a part of a supporting member 15. The housing 13 is made of an electrically insulating member. The terminal 16 is made of a metal member. The supporting member 15 (explained later) supports the terminal 16. In the drawings, the cables C are already connected to the terminals 16.

In the embodiment, an insertion hole 14 is provided in the housing 13 of each of the connector portions 11 to pierce an axis line direction of the cable corresponding to each terminal having a cable (shown in FIG. 5(A)). The insertion hole 14 is provided to insert the terminal to which the cable is connected. The four terminals having the cables in the connector portions 11 are supported with the supporting member 15 (explained later).

As shown in FIG. 5(A), the terminal 16 is provided with a holding portion 16A, a crimping portion 16B, a locking portion 16C, and a contact portion 16D. The holding portion 16A holds a coat distal portion of the cable C. The crimping portion 16B is crimped to connect to a central conductor C1 of the cable C. The locking portion 16C is provided to prevent the terminal 16 from coming off. The contact portion 16D is provided to contact a terminal of the connector for a circuit board that is a mating connector.

In the embodiment, the terminal 16 is made of a metal sheet, which is already publicly known and will not be explained further. The locking portion 16C has a protruding portion 16C-1 protruding toward a lower side in FIGS. 5(A) and 5(B). The contact portion 16D forms throat portion 16D-1 in a lower portion of two elastic pieces that extend downwardly. A terminal of the mating connector is elastically pressed to contact each other in the throat portion 16D-1.

In the embodiment, the terminal 16 having the cable C is inserted into an inside of the insertion hole 14 from a left side as shown in FIG. 5(A). The protruding portion 16C-1 of the terminal 16 is locked in a locking hole 21, and the contact portion 16D is positioned in a receiving groove 20. The locking hole 21 and the receiving groove 20 will be explained below.

In the embodiment, the housing 13 of each of the connector portions 11 holds the two terminals 16 having a cable in which the cables are parallel to each other. As shown in FIG. 1, the housing 13 of the connector portion 11 has an approximate rectangular solid outer shape, and an outer surface thereof is not flat.

In the embodiment, the housing 13 forms a fitting surface on each of four outer wall surfaces. The four outer wall surfaces extend in a fitting direction to the connector for a circuit board 30 or the mating connector, and constitute an outer peripheral surface.

In the embodiment, the four outer wall surfaces include an inward outer wall surface 13A on a side of the connecting portion 12, an outward outer wall surface 13B, a cable side outer wall surface 13C in a cable extending direction, and a terminal side outer wall surface 13D. The outward outer wall surface 13B is positioned to be on an opposite side of the inward outer wall surface 13A of the connecting portion 12 side. The terminal side outer wall surface 13D is positioned on a terminal side of the opposite side of the cable side outer wall surface 13C.

In the embodiment, a front side (a lower surface in FIG. 1) 13E and a rear side (an upper face in FIG. 1) 13F are formed as surfaces that are perpendicular to the fitting direction. The front side 13E faces the connector for a circuit board 30 or the mating connector. The rear side 13F is provided on the opposite side of the front side 13E.

In the embodiment, among the four outer wall surfaces, the outward outer wall surface 13B and the cable side outer wall surface 13C form the fitting surfaces perpendicular to each other. The fitting surface closely contacts a corresponding fitting surface of the connector for a circuit board 30. Further, the fitting surface determines a fitting position in a direction perpendicular to the fitting surface as a reference point and guides the connectors to be fitted with each other in the fitting direction.

A protruding portion 17 is provided in the three sides in which the three outer wall surfaces 13A, 13B, and 13C are situated. That is, the protruding portion 17 is not provided in the side in which the terminal side outer wall surface 13D is situated. A front edge of the protruding portion 17 protrudes frontward from the front side 13E. The protruding portion 17 has a taper portion on the front edge thereof.

In the embodiment, the three outer wall surfaces; that is, the inward outer wall surface 13A, the outward outer wall surface 13B, and the cable side outer wall surface 13C, are formed to extend frontward from the front side 13E. Accordingly, the fitting surfaces that are formed on the outward outer wall surface 13B and the cable side outer wall surface 13C extend to reach the protruding portion 17. The protruding portion 17 is provided forward of a position of the front side 13E.

The protruding portion 17 protrudes frontward from the lower edges of the outer wall surfaces 13A, 13B, and 13C. The protruding portion 17, coupled with the inner surface thereof and the front side 13E, forms a recess portion 19. The recess portion 19 is open toward a front and the terminal side outer wall surface 13D. The protruding portion 17 forms a surface to face the connecting portion 12 in the inward outer wall surface 13A. The inward outer wall surface 13A is formed in a band shape in a longitudinal direction of the cable C along a front edge of the protruding portion 17 and extends to the bottom surface of the connecting portion 12.

An opening portion of the insertion hole 14 is formed in the cable side outer wall surface 13C, as described above. Further, a flange portion 18 is provided in an upper edge and a side edge of the insertion hole 14 in a cable extending direction. An upper face of the flange portion 18 constitutes a part of the rear side (upper face) 13F of the connector portion 11. Accordingly, the fitting surface that is formed by the cable side outer wall surface 13C forms a U-character band shape along the lower edge and the side edge of the insertion hole 14 when viewed from the cable extending direction.

As described above, the front side 13E of the housing 13 of the connector portion 11, coupled with the inner surface of the protruding portion 17, forms the recess portion 19. Two kinds of grooves are open in the front side 13E to communicate with the insertion hole 14 for the terminal. One is, as shown in FIG. 5(A), the receiving groove 20, and the other is the locking hole 21.

In the embodiment, the receiving groove 20 is positioned to correspond to the contact portion 16D of the terminal 16 and receives a corresponding portion of the terminal of the mating connector. The protruding portion 16C-1 of the locking portion 16C of the terminal 16 is locked in the locking hole 21.

In the embodiment, the protruding portion 17 is a continuing protruding portion. Alternatively, the protruding portion 17 may be a plurality of protruding portions that is partially protruded. In this case, the outer wall surfaces 13A, 13B, and 13C are partially open in the recess portions at positions corresponding to the protruding portions.

The rear side 13F that is provided on an opposite side of the front side 13E is substantially flat.

In the embodiment, the connecting portion 12 connects the connector portions 11 that are formed to be symmetrical to each other at a position symmetrical with respect to the center surface. The connecting portion 12 connects the connector portions 11 on an upper portion side.

Further, the connecting portion 12 is provided with a locking arm portion 22 having a window 22A at a position that corresponds to the terminal side outer wall surface 13D in an axis line direction of the cable C. The locking arm portion 22 having the window 22A hangs downwardly.

Further, the locking arm portion that constitutes a part of the supporting member hangs downwardly in a position that corresponds to the cable side outer wall surface 13C. The supporting member will be explained below. Accordingly, a recess portion 23 is provided in a lower surface side of the connecting portion 12. The recess portion 23 is surrounded and opens frontward and downward.

In the embodiment, the recess portion 23 includes a main recess portion 23A and a sub recess portion 23B. The main recess portion 23A is provided on a side of the locking arm portion 22. The sub recess portion 23B has a larger recess on a side of the locking arm portion 22.

As shown in FIGS. 2(A) and 2(B), the supporting member 15 is provided integrally with a plate portion 24 having a plate shape, a supporting member connecting portion 25, extending portions 26, attachment arm portions 27, and supporting arm portions 28.

In the embodiment, the plate portion 24 contacts with a rear side of the connecting portion 12. The supporting member connecting portion 25 droops from one of sides (the cable side) of the plate portion 24. The extending portions 26 extend from both side portions of the supporting member connecting portion 25 along the side in a right-to-left direction. The attachment arm portions 27 extend from both side portions of the supporting member connecting portion 25 in the opposite side of the cable extending direction. The supporting arm portions 28 extend in parallel to the attachment arm portion 27 from each of the extending portions 26.

In the embodiment, a taper portion is formed in a distal portion of the attachment arm portion 27. Further, a taper portion having a step with a shoulder portion is formed in a distal portion of the supporting arm portion 28. The supporting member 15 is attached to the connecting portion 12 and the housing 13 from the opposite direction of the extending direction of the cable C on the extending side of the cable C. Accordingly, the supporting arm portion 28 enters the insertion hole 14 of the connector portion 11. Further, the supporting arm portion 28 abuts against the protruding portion 16C-1 of the terminal 16 at the distal portion thereof.

As described above, the connector for a circuit board 30 receives the connector for a cable 10. As shown in FIGS. 1, 3(A), and 4(A), the connector for a circuit board 30 forms a space having a recess shape that is appropriate for fitting into the connector for a cable 10. The connector for a circuit board 30 is attached to a circuit board (not shown) on the lower surface thereof.

In the embodiment, the connector for a circuit board 30 has two connector portions 31. The connector portions 31 are away from each other at an interval corresponding to the connector for a cable 10. The connector portions 31 are connected through the connecting portion 32 that is positioned between the connector portions 31.

Similar to the connector for a cable 10, housings 33 of the connector portions 31 and the connecting portion 32 are integrally formed to be a housing of the connector for a circuit board 30. Further, the connector for a circuit board 30 is provided to be symmetrical with respect to a center surface that passes through a center of the connecting portion 32.

In the embodiment, a receiving recess portion 34 is provided in the housing 33 of each of the connector portions 31. The receiving recess portion 34 is provided to receive the connector portion 11 of the connector for a cable 10. The housing 33 that forms the receiving recess portion 34 includes a side outer wall 36 and a terminal side outer wall 37.

In the embodiment, the side outer wall 36 rises from a bottom wall 35 on a side edge thereof that is situated on a furthest side from the connecting portion 32. The terminal side outer wall 37 rises from the bottom wall 35 on a side edge of a terminal side thereof. The inner wall surfaces 36-1 and 36-2 are formed inside the outer wall 36. A height of each of the outer walls 36 and 37 is sized to store the connector portion 11 of the connector for a cable 10 substantially and completely in the fitting direction.

In the embodiment, a recess portion 38 is provided in the bottom wall 35 at a circumference position along the outer wall surface of the connector portion 11 of the connector for a cable 10. The recess portion 38 is provided as a groove having a rectangle circle shape. That is, the bottom wall 35 forms the recess portion 38 at the circumference position and receiving surfaces 39 and 39′. The receiving surfaces 39 and 39′ are surrounded by the recess portion 38 and are tangent to or face to be adjacent to the front side 13E of the connector portion 11 of the connector for a cable 10.

In the embodiment, an erect piece 40 is provided on the receiving surface 39 to be adjacent to an inner surface of the terminal side outer wall 37. Further, a terminal holding groove 41 is formed between the erect piece 40 and the inner surface of the terminal side outer wall 37. A terminal 42 having a U-character plate shape is held in the terminal holding groove 41. The terminal holding groove 41 extends to reach the receiving surface 39 to store a lower edge of the terminal 42 having a U-character shape. The terminal 42 is held in the terminal holding groove 41.

In the embodiment, the terminal 42 is provided with a contact portion 42A in a U-character leg portion thereof. Further, the terminal 42 pierces the bottom wall 35 and protrudes outwardly from the housing 33, and a connection portion 42B and an attachment leg 42C are formed in the protruding portions thereof (shown in FIGS. 4(A) and 5(A)).

In the embodiment, the connection portion 42B and the attachment leg 42C may protrude outwardly from the housing 33 on a cable extending side or an outer wall side in an extending direction of the cable C or a direction perpendicular to the extending direction of the cable C to be connected to a surface of the circuit board.

In the embodiment, the recess portion 38 having a square ring shape is formed as a groove. Alternatively, the connecting portion 32 may connect the receiving surface 39 and the receiving surface 39′ or the receiving surface 39 and the connector portions 31. Further, the housing or the terminal that extends may connect the receiving surface 39 and the outer wall. Further, a plurality of groove portion may be formed partially.

In the embodiment, the connecting portion 32 comprises a main connecting portion 32A and a sub connecting portion 32B. The main connecting portion 32A is fitted into the main recess portion 23A of the connecting portion 12 of the connector for a cable 10. The sub connecting portion 32B is fitted into the sub recess portion 23B of the connecting portion 12 of the connector for a cable 10.

When the connectors are fitted with each other, an upper face of the main connecting portion 32A is situated on an upper side of the receiving surface 39 of the bottom wall 35 or in a direction that is close to the connector for a cable 10. The bottom wall 35 forms the receiving recess portion 34 of the connector portion 31. Accordingly, an upper face of the sub connecting portion 32B is situated in a further upper side. Sidewall surfaces of the main connecting portion 32A and the sub connecting portion 32B on a side of the connector portion 31 form a part of the receiving surface 38.

In the embodiment, the housing of the connector for a circuit board 30 is open and has no external peripheral wall on the cable extending side of the connector for a cable 10. Accordingly, the cable C can extend outwardly when the connector for a cable 10 is fitted. Further, on the terminal side that is on the opposite side of the cable extending side, the external peripheral wall is open in a range that corresponds to the connecting portion 32 or between the two connector portions 31. The locking arm portion 22 of the connector for a cable 10 can enter the open portion of the external peripheral wall.

The connector for a cable 10 and the connector for a circuit board 30 of the configurations described above are fitted with each other and are electrically connected as described below. The terminal 42 that is crimped to the cable C is inserted into the insertion hole 14 of the connector for a cable 10.

The connector portions 11 of the connector 10 having a cable can be obtained as described above. The connector portions 11 of the connector 10 having a cable are fitted into the connector portions 31 of the connector for a circuit board 30. As shown in FIGS. 3(A) and 3(B), at the beginning of the fitting, the outer wall surface 13B of the connector for a cable 10 is guided and fitted into the inner wall surface 36-1 of the connector for a circuit board 30. Further, the outer wall surface 13C is guided and fitted into the inner wall surface 36-2. Further, the connecting portion 32 of the connector for a circuit board 30 is fitted into the recess portion 23 of the connector for a cable 10.

As shown in FIGS. 4(A), 4(B), 5(A) and 5(B), when the connector portions 11 are guided and fitted into the connector portions 31 almost completely, the front side protruding portion 17 of the connector for a cable 10 is guided and fitted into the recess portion 38 of the connector for a circuit board 30. Accordingly, the fitting of the connectors is completed.

In the embodiment, in the connector for a cable 10 and the connector for a circuit board 30 formed as described above, the fitting surfaces that guide in the fitting direction are formed on the outward outer wall surface 13B and the cable side outer wall surface 13C of the connector for a cable 10. The outward outer wall surface 13B and the cable side outer wall surface 13C are perpendicular to each other and reach the protruding portion 17.

Further, the fitting surface that guides in the fitting direction is also formed on the inner surface of the recess portion 38 of the connector for a circuit board 30 that corresponds to the outward outer wall surface 13B and the cable side outer wall surface 13C. Accordingly, the fitting position is positioned in the both directions that are perpendicular to each other.

Further, the fitting surface extends to the front side of the front side 13E of the connector portion 11 of the connector for a cable, or the lower side of the receiving surface 39 of the connector for a circuit board 30 that corresponds to the front side 13E. Accordingly, a large fitting length and a large fitting area can be obtained, which stabilizes the fitting. Further, a distance between the fitting surfaces of the connector portions can be large due to the connecting portion, thereby effectively preventing the connector from obliquely fitting.

Further, a space distance between the terminals 16 of the both connector portions 11 in the connector for a cable 10 is enlarged due to the connecting portion 12. Further, a creepage distance is enlarged due to the protruding portion 17 that is situated between the terminals 16 of the both connector portion 11, the recess portion 23 of the connecting portion 12, the recess portion 38 that is situated between the both connector portions 31 of the connector for a circuit board 30, and the connecting portion 32.

Accordingly, an insulation strength between the terminals 16 becomes high. Further, in the connector for a circuit board 30, similar to the connector for a cable 10, a space distance between the terminals of the both connector portions is enlarged due to the connecting portion 32. Further, a creepage distance between the terminals of the both connector portions is enlarged due to the recess portion 38.

As shown in FIGS. 3(B), 4(B), and 5(B), the cable C fits the connector for a cable 10 that is wired into the connector for a circuit board 30 that is attached to the circuit board when used. The connector portion of the connector for a cable 10 is fitted into the receiving recess portion 34 of the connector for a circuit board 30. The terminal 16 is connected to the terminal 42. Further, the locking arm portions 22 and 25 of the connector 10 are locked with the corresponding portions of the connector for a circuit board 30, thereby preventing the connector from coming off.

The present invention is not limited to the embodiments that are shown in the drawings, and various changes may be made. For example, three or more connector portion may be provided instead of two.

In this case, the connecting portion is provided between the connector portions. A distance between the connector portions, or a width of the connecting portion, is arbitrarily determined according to the voltage between the terminals in the connector portion. Further, the shape or size of the protruding portion and the recess portion are arbitrarily determined according to the space distance and the creepage distance.

The disclosure of Japanese Patent Application No. 2007-139210, filed on May 25, 2007, is incorporated in the application by reference.

While the invention has been explained with reference to the specific embodiments of the invention, the explanation is illustrative and the invention is limited only by the appended claims.

What is claimed is:

1. A cable connector to be fitted into a circuit board connector in a fitting direction, comprising:
a first connector portion having a terminal to be connected to a cable, said first connector portion including an outer wall surface and a protruding portion so that a first fitting surface is formed on the outer wall surface and the protruding portion; and
a first connecting portion integrated with the first connector portion.

2. The cable connector according to claim 1, wherein said first connector portion is arranged to fit in a receiving recess portion of the circuit board connector so that a front side thereof faces a bottom surface of the receiving recess portion, said protruding portion protruding beyond the front side.

3. The cable connector according to claim 1, wherein said outer wall surface includes two wall surfaces perpendicular to each other.

4. The cable connector according to claim 1, wherein said protruding portion is disposed between the terminal and an adjacent terminal of an adjacent first connector portion.

5. The cable connector according to claim 2, wherein said first connecting portion includes a front portion recessed with respect to the front side of the first connector portion in the fitting direction.

6. A circuit board connector to be fitted into a cable connector in a fitting direction, comprising:
a second connector portion having a receiving recess portion for accommodating the cable connector, said second connector portion including an inner wall surface and a recess portion so that a second fitting surface is formed on the inner wall surface and the recess portion; and
a second connecting portion integrated with the second connector portion.

7. The circuit board connector according to claim 6, wherein said second connector portion is arranged to accommodate the cable connector so that a bottom surface of the receiving recess portion faces a front side of the cable connector, said recess portion accommodating a protruding portion of the cable connector.

8. The circuit board connector according to claim 6, wherein said inner wall surface includes two wall surfaces perpendicular to each other.

9. The circuit board connector according to claim 6, wherein said recess portion is disposed between terminals of the cable connector when the circuit board connector is fitted to the cable connector.

10. The circuit board connector according to claim 7, wherein said second connecting portion includes a front portion protruding with respect to the bottom surface of the receiving recess portion in the fitting direction.
